(19) United States
(12) Patent Application Publication
(10) Pub. No.: US 2019/0308133 A1
(43) Pub. Date: Oct. 10, 2019

(54) IN-LINE PIPE CONTACTOR

(71) Applicants: Sunder Ramachandran, Sugar Land, TX (US); James Ott, Kilgore, TX (US); Mahendra Ladharam Joshi, Katy, TX (US); Pejman Kazempoor, Edmond, OK (US); Grant Lynn Hartman, Oklahoma City, OK (US); Lily Jiang, Oklahoma City, OK (US); Matthew L. George, Oklahoma City, OK (US)

(72) Inventors: Sunder Ramachandran, Sugar Land, TX (US); James Ott, Kilgore, TX (US); Mahendra Ladharam Joshi, Katy, TX (US); Pejman Kazempoor, Edmond, OK (US); Grant Lynn Hartman, Oklahoma City, OK (US); Lily Jiang, Oklahoma City, OK (US); Matthew L. George, Oklahoma City, OK (US)

(73) Assignee: Baker Hughes, a GE company, LLC, Houston, TX (US)

(21) Appl. No.: 16/376,214

(22) Filed: Apr. 5, 2019

Related U.S. Application Data
(60) Provisional application No. 62/653,825, filed on Apr. 6, 2018.

(51) Int. Cl. B01D 53/14; B01D 53/18

(52) U.S. Cl. CPC B01D 53/1406; B01D 53/1456; B01D 53/1493; B01D 2252/202; B01D 2256/24; B01D 2252/103; B01D 53/185

(57) ABSTRACT

A method of removing impurities from formation fluids includes introducing a formation fluid into a first end of a first tubular, directing the formation fluid along a first flow path toward a second end of the first tubular, redirecting the formation fluid along a second flow path defined by a second tubular arranged radially outwardly of the first flow path toward the first end, spraying a treatment fluid along the first flow path into the formation fluid, and directing a treated formation fluid through an outlet fluidically connected to the second flow path.

### CROSS REFERENCE TO RELATED APPLICATIONS

This application claims the benefit of an earlier filing date from U.S. Provisional Application Ser. No. 62/653,825 filed Apr. 6, 2018, the entire disclosure of which is incorporated herein by reference.

### BACKGROUND

In the resource exploration and recovery industry, fluid streams such as natural gas and hydrocarbons may contain undesirable impurities. It is desirable to remove compounds such as hydrogen sulfide, Sulphur dioxide, nitrogen oxides (NOx) and other impurities from the fluid stream. Various systems are employed to remove such impurities. Liquid atomizers that employ ultrasound techniques may be employed to scavenge hydrocarbons from a fluid stream. Such systems typically include long treatment lengths that increase system costs and complexity. Accordingly, the art would be receptive to a system for treating impurities that may possess a smaller footprint as comparted to existing systems.

### SUMMARY

Disclosed is a method of removing impurities from formation fluids including introducing a formation fluid into a first end of a first tubular, directing the formation fluid along a first flow path toward a second end of the first tubular, redirecting the formation fluid along a second flow path defined by a second tubular arranged radially outwardly of the first flow path toward the first end, spraying a treatment fluid along the first flow path into the formation fluid, and directing a treated formation fluid through an outlet fluidically connected to the second flow path.

### BRIEF DESCRIPTION OF THE DRAWINGS

The following descriptions should not be considered limiting in any way. With reference to the accompanying drawings, like elements are numbered alike:

FIG. 1 depicts cross-sectional side view of an in-line pipe contactor, in accordance with an aspect of an exemplary embodiment;

FIG. 2 depicts a first end view of the in-line pipe contactor, in accordance with an exemplary embodiment;

FIG. 3 depicts a second end view of the in-line pipe contactor, in accordance with an exemplary embodiment;

FIG. 4 depicts a partial cross-sectional side view of an in-line pipe contactor, in accordance with an aspect of an exemplary embodiment;

FIG. 5 depicts a block diagram illustrating a control and communication system for the in-line pipe contactor, in accordance with another aspect of an exemplary embodiment;

FIG. 6 depicts an input end of an in-line pipe contactor, in accordance with an aspect of an exemplary embodiment;

FIG. 7 depicts a parallel arrangement of in-line pipe contactors, in accordance with an aspect of an exemplary embodiment;

FIG. 8 depicts a series arrangement of in-line pipe contactors, in accordance with another aspect of an exemplary embodiment;

FIG. 9 depicts cross-sectional side view of an in-line pipe contactor system, in accordance with an aspect of an exemplary embodiment;

FIG. 10 depicts cross-sectional side view of an in-line pipe contactor including a demister, in accordance with an aspect of an exemplary embodiment;

FIG. 11 depicts a cross-sectional side view of a gas inlet including a venturi for the in-line pipe contactor, in accordance with an aspect of an exemplary embodiment;

FIG. 12 depicts a cross-sectional side view of an in-line pipe contactor including a gas bubbler, in accordance with an aspect of an exemplary embodiment;

FIG. 13 depicts a gas bubbler tube for the in-line pipe contactor of FIG. 12, in accordance with an aspect of an exemplary embodiment;

FIG. 14 depicts a gas bubbler tube for the in-line pipe contactor of FIG. 12, in accordance with another aspect of an exemplary embodiment;

FIG. 15 depicts cross-sectional side view of an in-line pipe contactor including tubular provided with a plurality of baffles, in accordance with an aspect of an exemplary embodiment; and

FIG. 16 depicts one of the plurality of baffles for the in-line pipe contactor of FIG. 15, in accordance with an aspect of an exemplary embodiment.

### DETAILED DESCRIPTION

A detailed description of one or more embodiments of the disclosed apparatus and method are presented herein by way of exemplification and not limitation with reference to the Figures.

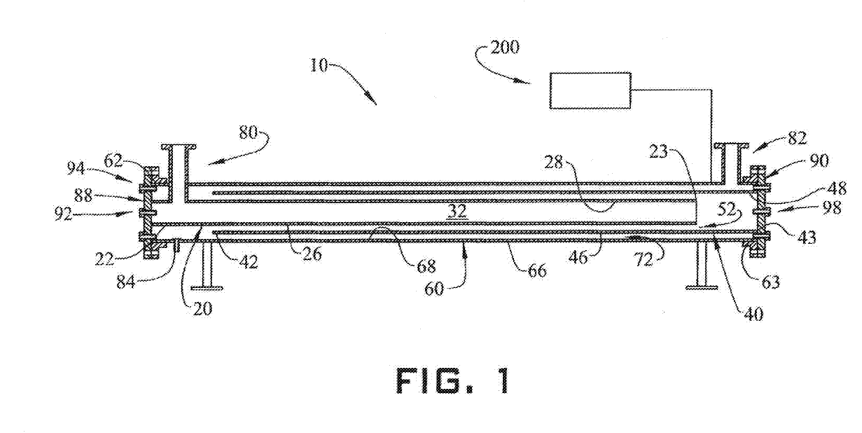

An in-line pipe contactor (IPC), formed in accordance with an exemplary embodiment, is indicated generally at 10 in FIG. 1. IPC 10 includes a first tubular 20 having a first end 22 and a second end 23. An outer surface 26 and an inner surface 28 extend between first and second ends 22 and 23. Inner surface 28 defines a first flow path 32. In an embodiment, outer surface 26 and inner surface 28 may include a hydrophobic coating (not separately labeled). A second tubular 40 is arranged radially outwardly of first tubular 20.

Second tubular 40 includes a first end portion 42 and a second end portion 43. An outer surface portion 46 and an inner surface portion 48 extend between first end portion 42 and second end portion 43. Inner surface portion 48, together with outer surface 28 of first tubular 20 define a second flow path 52. First end portion 42 is spaced axially inwardly relative to first end 22 and second end portion 43 is spaced axially outwardly of second end 23. In an embodiment, outer surface portion 46 and inner surface portion 48 may include a hydrophobic coating (not separately labeled). A third tubular 60 is arranged radially outwardly of second tubular 40.

Third tubular 60 includes a first end section 62 and a second end section 63. An outer surface section 66 and an inner surface section 68 extend between first end section 62 and second end section 63. Inner surface section 68 together with outer surface portion 66 define a third flow path 72. In an embodiment, inner surface section 68 may include a hydrophobic coating (not separately labeled). An inlet 80 may extend through third tubular 60 and first tubular 20 and fluidically connect with first flow path 32. An outlet 82 may extend through third tubular 60 and fluidically connect with third flow path 72. IPC 10 may also be provided with one or more drains such as indicted at 84.

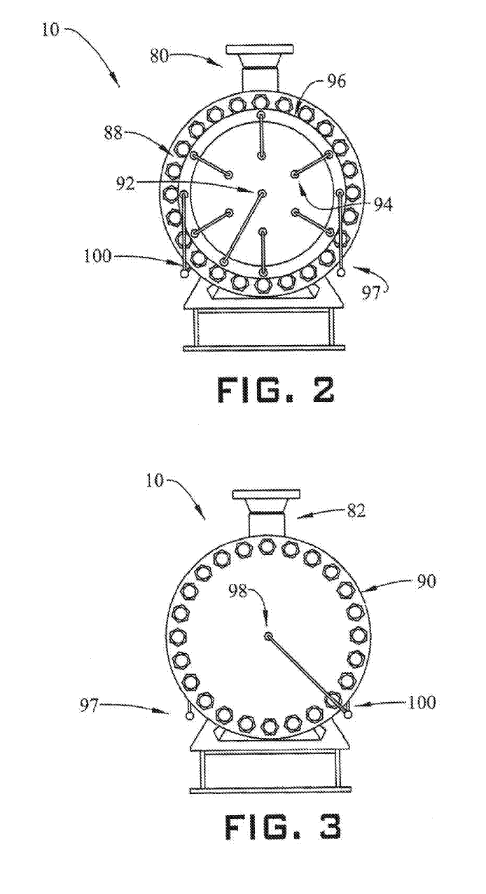

Referring to FIGS. 2 and 3 and with continued reference to FIG. 1, a first end cap 88 is connected to first end 22 of first tubular 20 and first end section 62 of third tubular 60. A second end cap 90 is connected with second end portion 43 of second tubular 40 and second end section 63 of third tubular 60. First end cap 88 supports a first central atomizer 92 and a plurality of atomizers, indicated generally at 94, arranged in an annular array. First central atomizer 92 and plurality of atomizers 94 may be connected to a manifold 96 having an inlet 97. Second end cap 90 supports a second central atomizer 98 that may be fluidically connected with manifold 96 through a conduit 100.

First central atomizer 94 is directed along first flow path 32 in a first direction and second central atomizer 98 is directed along first flow path 32 and second flow path 52 in a second, opposing direction. Plurality of atomizers 96 are directed along second flow path 52 and third flow path 72. Atomizers 94, 96, and 98 deliver selected amounts of a treatment fluid into formation fluids passing through IPC 10 as will be discussed herein. Atomizers 94, 96, and 98 may take on various forms including pressure assist atomizers, gas assist atomizers, ultrasonic atomizers and the like. The treatment fluid may be selected to eliminate impurities from the formation fluid. The particular treatment fluid employed may depend on the formation fluid passing through HPC 10.

Examples of treatment fluids may include Monoethanol triazine mixtures with water. Other mixtures can include monoethanol triazine mixture with water and formaldehyde; MEA Triazine water mixtures with scale inhibitors); Aldehyde and dialdehyde H2S scavengers such as glyoxal; Synergistic application of dialdehyde such as glyoxal and a nitrogen containing H2S scavenger such as MEA Triazine; Methyl amine (MMA) triazine; MMA triazine and water mixtures, mixtures with water and scale inhibitor, water mixtures with formaldehyde; Formaldehyde, formaldehyde water mixtures); formaldehyde butanol reaction products, and formaldehyde phenol reaction products. Transition metal carboxylate such as Zinc carboxylates; Zinc aryl and alkyl carboxylates; metal salts such as Zinc carboxylate with an oil soluble formaldehyde reaction product such as dibutyl formaldehyde reaction product; Aldehyde Ammonia Trimer; Mixed aldehydes such as formaldehyde, aliphatic aldehydes, glyoxal and aromatic aldehydes such as cinnamaldehyde; Bisoxazolidine hydrogen sulfide scavengers; 1,6 dihydroxy 2,5 dioxahexane; Mixtures of Water soluble aldehydes such as 1,6 dihydroxy 2,5 dioxahexane with Transition metal carboxylates such as Zinc carboxylate; and combinations of the above chemistries with scale and corrosion inhibitors. All of these fluids can be mixed with one another and can include all mixtures with surfactants. Other fluids can be hydroxides such as sodium hydroxide and potassium hydroxides. These fluids are also used to neutralize sulfur dioxide and nitrogen oxides (NOx). Both MEA and MMA triazines as well as various mixtures thereof, including different amines such as monoethanol amine and methyl amine can be used to neutralize sulfur dioxide and nitrogen oxides (NOx).

In accordance with an exemplary aspect, a flow of formation fluids may be introduced into IPC 10 through inlet 80. The formation fluids may flow along first flow path 32 towards second end cap 90. The formation fluids may then be directed back along second flow path 52 before being turned toward third flow path 72 and allowed to exit through outlet 82. While passing along first, second, and third flow paths 32, 52, and 72, atomizers 94, 96, and 98 introduce a treatment fluid into the formation fluids. The treatment fluid interacts with constituents of the formation fluids to reduce selected impurities.

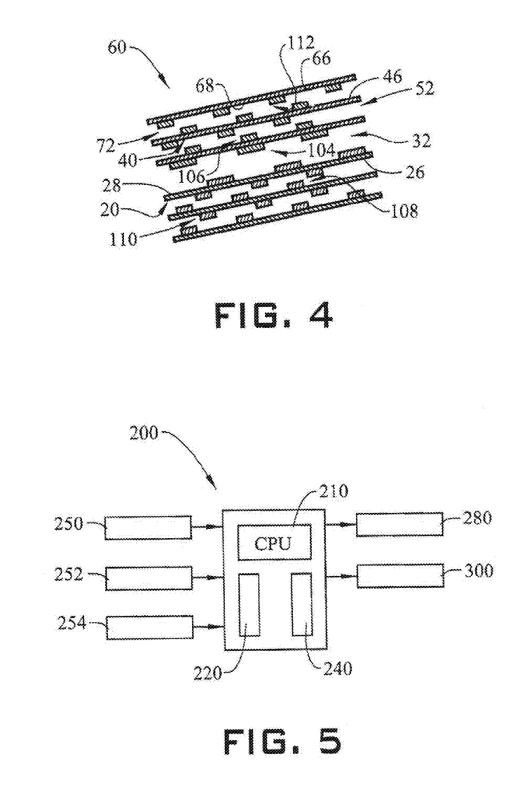

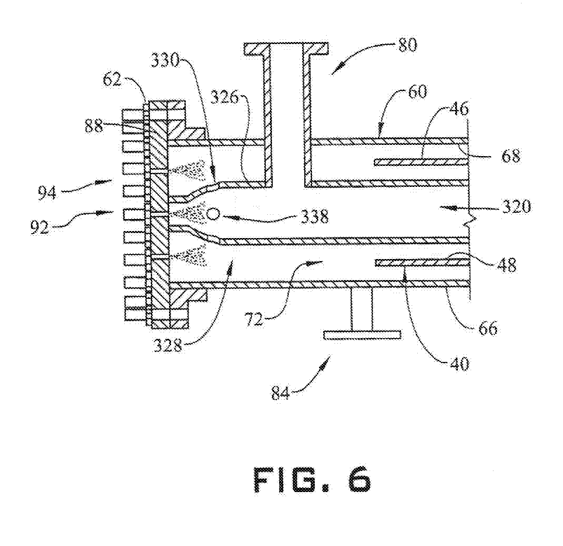

In order to enhance exposure to the treatment fluids, a turbulence may be introduced into the formation fluid passing along first, second, and third flow paths 32, 52, and 72. For example, as shown in FIG. 4 a first plurality of baffles or trip inducers 104 may be arranged along inner surface 28, a second plurality of baffles or trip inducers 106 may be arranged along outer surface 26, a third plurality of baffles or trip inducers 108 may be arranged along inner surface section 48, a fourth plurality of baffles or trip inducers 110 may be arranged along outer surface section 46, and/or a fifth plurality of baffles or trip inducers 112 may be arranged along inner surface section 68. The number, location, and arrangement of trip inducers may vary.

The system may inject a single chemical treatment fluid or combinations of different chemical treatment fluids to improve performance.

FIG. 5 depicts a control and communication system 200 operatively connected to in-line pipe contactor 10, in accordance with an exemplary aspect. Control and communication system 200 includes a central processor unit (CPU) 210 operatively connected to a treatment fluid control module 220 and a formation fluid monitoring module 240. Control and communication system 200 may be connected to a first sensor 250 arranged at inlet 80, a second sensor 252 arranged at outlet 82 and a third sensor 254 arranged at manifold 96. Sensors 250, 252, and 254 may be configured to detect impurities, such as hydrogen sulfide (H2S), Sulphur oxides (SOₓ), and nitrogen oxides (NOₓ).

The particular impurity sensed may vary and could be process dependent. For example, sulfur dioxide and nitrogen oxides may develop from an oxidation of fuels such as from in refineries and other industrial operations. Carbon dioxide from flue gas may be used to enhance oil recovery. The flue gas, being a product of combustion, may can contain sulfur dioxide and nitrogen oxides (NOx). Of course, other impurities may also exist.

First sensor 250 may monitor an impurities in the formation fluids entering in-line pipe contactor 10 while second sensor 252 may monitor impurities in the formation fluids passing from in-line pipe contactor 10. Third sensor 254 may monitor impurities on the treatment fluid passing into manifold 96 so that controller and communication system 200 may establish a selected distribution percentage of treatment fluid passing into first central atomizer 92, plurality of atomizers 94 and second central atomizer 98. The selected distribution of treatment fluid establishes a selected quality of formation fluids passing from in-line pipe contactor 10.

CPU 210 may then communicate with a treatment fluid control 280 to adjust an amount and distribution percentage of treatment fluids passing into in-line pipe contactor 10 to remove a desired amount of impurities based on signals from first and second sensors 250 and 252. Control and communication system 200 may also communicate with and may receive command signals from, a remote monitoring station 300. Communication between control and communication system 200 and sensors 250, 252, and 254, treatment fluid controller 280, and remote monitoring system 300 may be wired, wireless, and/or combinations thereof.

Reference will now follow to FIG, 6, wherein like reference numerals represent corresponding parts in the respective views, in describing a first tubular 320 in accordance with another aspect of an exemplary embodiment. First tubular 320 includes an outer surface 326 and a first end 328 connected with first end cap 88. First end 328 defines a conical or tapered surface 330 that is angled radially inwardly. Tapered surface 330 may include one or more openings, such as indicated at 338. Openings 338 allow flow flowing toward first end cap 88 from flow path 52 to enter into first end 328. Directing fluid into openings 338 provides a flow that may impart movement to any fluids that may be stagnating in first tubular 320 at first end 328. Further, tapered surface 320 provide additional flow area for treatment fluids passing from atomizers 94.

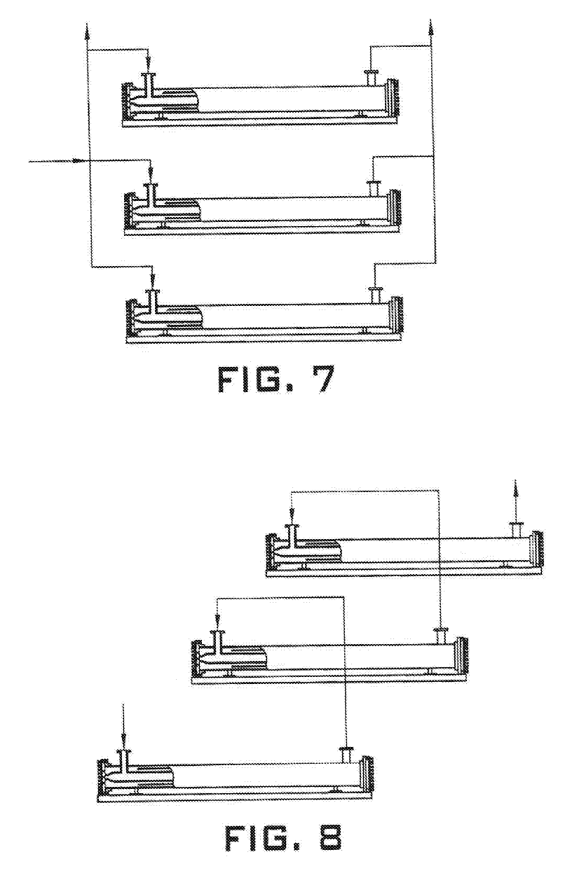

In-line pipe contactor 10 provides a system for exposing formation fluids to a treatment fluid for a selected duration. By employing multiple concentric tubulars, treatment time of the formation fluid may be increased without increasing an overall length of the in-line pipe contactor. Further, in-line pipe contactor 10 may be connected to other in-line pipe contactors to further enhance treatment of formation fluids. For example, a parallel connection of in-line pipe contactors, as shown in FIG. 7, may be employed to process a high gas capacity.

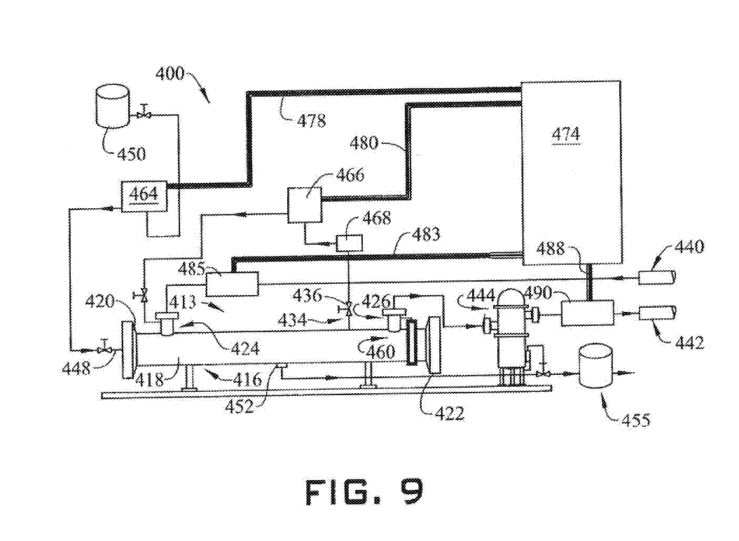

In-line pipe contactors may be connected in series, such as shown in FIG. 8, when formation fluids are shown to include higher concentrations of undesirable constituents. It should be further appreciated that the particular connection of in-line pipe contactors may be varied. For example, the inlet and the outlet may be switched. It should be further appreciated that the in-line pipe contactor may be mounted vertically in installations where space is a concern. Still further, it should be appreciated that the in-line pipe contactor may be employed in combination with other scavenger units for sweetening gas to meet various H2S specifications.

Reference will now follow to FIG. 9 in describing an in-line pipe contactor system (IPCS) 400. Inline pipe contactor system 400 includes an in-line pipe contactor (IPC) 413 including a tubular 416 defining an outer housing 418. Tubular 416 includes a first end section 420 and a second, opposing end section 422. A gas inlet 424 is arranged proximate to first end section 420 and a gas outlet 426 is arranged proximate to second end section 422. As will be detailed herein, IPC 413 also includes a recycle gas inlet 434 having a valve 436.

A gas supply 440 is fluidically connected to gas inlet 424. Gas supply 440 may deliver untreated gas to in-line pipe contactor 413 to be treated. A gas delivery system 442 is connected to gas outlet 428 for delivering treated gas to a storage facility (not shown). Prior to passing to gas delivery system, the gas may pass through a gas/liquid separator 444 that removes residual treatment liquid. IPC 413 also includes a liquid inlet 448 connected to a fresh liquid source 450 and a liquid drain 452 that is fluidically connected to a spent liquid storage member 455. A level indicator 460 may be provided in tubular 416 to provide an indication of liquid level contained in in-line pipe contactor 413. A first or supply pump 464 may be coupled between fresh liquid source 450 and liquid inlet 448. Also, a second or recycle pump 466 may be connected between recycle outlet 434 and gas inlet 424 via a filter 468.

In an embodiment, ICPS 400 includes a controller 474 that may include a CPU, and a non-volatile memory upon which may be stored a set of instructions for controlling operation of in-line pipe contactor 413. Controller 474 is coupled to supply pump 464 through a first cable 478 and to recycle pump 466 through a second cable 480. In addition, controller 474 includes a third cable 483 that connects with a first H2S analyzer 485 and a fourth cable 488 that connects with a second H2S analyzer 490. In this manner, controller 474 may monitor how much Hydrogen sulfides are removed from the gas passing through IPC 413.

Further, controller 474 may employ algorithms stored in memory to drive supply pump 464 and recycle pump 466 to control fresh liquid injection and recycle liquid injection. Fresh liquid injection and recycle liquid injection rates may be based upon a sensed hydrogen sulfide differential between inlet gas and outlet gas. In an embodiment, liquid recycle rate may be from about 10% to about 99.9% or more of the liquid flowing through in-line pipe contactor 413. Recycling the liquid reduces the amount of fresh liquid needed to achieve a desired gas sweetening (hydrogen sulfide removal) effect.

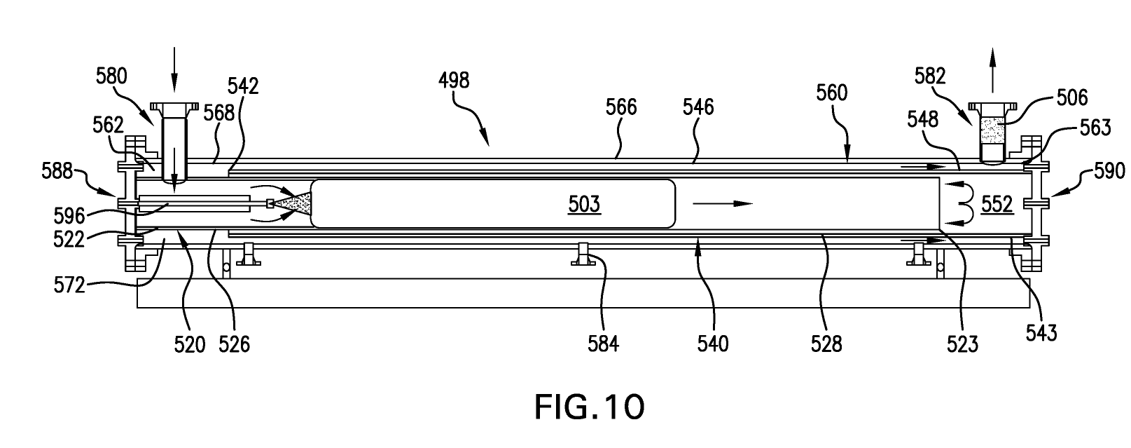

Reference will now follow to FIG. 10 while describing an in-line pipe contactor (IPC) 498, formed in accordance with another exemplary embodiment. IPC 498 includes a first tubular 520 having a first end 522 and a second end 523. An outer surface 526 and an inner surface 528 extend between first and second ends 522 and 523. Inner surface 528 defines a first flow path 532. In an embodiment, outer surface 526 and inner surface 528 may include a hydrophobic coating (not separately labeled). A second tubular 540 is arranged radially outwardly of first tubular 520.

Second tubular 540 includes a first end portion 542 and a second end portion 543. An outer surface portion 546 and an inner surface portion 548 extend between first end portion 542 and second end portion 543. Inner surface portion 548, together with outer surface 528 of first tubular 520 define a second flow path 552. First end portion 542 is spaced axially inwardly relative to first end 522 and second end portion 543 is spaced axially outwardly of second end 523. In an embodiment, outer surface portion 546 and inner surface portion 548 may include a hydrophobic coating (not separately labeled). A third tubular 560 is arranged radially outwardly of second tubular 540.

Third tubular 560 includes a first end section 562 and a second end section 63. An outer surface section 566 and an inner surface section 568 extend between first end section 562 and second end section 563. Inner surface section 568 together with outer surface portion 566 define a third flow path 572. In an embodiment, inner surface section 568 may include a hydrophobic coating (not separately labeled). An inlet 580 may extend through third tubular 560 and first tubular 520 and fluidically connect with first flow path 532. An outlet 582 may extend through third tubular 560 and fluidically connect with third flow path 572. IPC 498 may also be provided with one or more drains such as indicted at 584.

In a manner similar to that described herein, a first end cap 588 is connected to first end 522 of first tubular 520 and first end section 562 of third tubular 560. A second end cap 590 is connected with second end portion 543 of second tubular 540 and second end section 563 of third tubular 560. First end cap 588 supports a central atomizer 596 and a first plurality of atomizers (not shown) and second end cap 590 supports a second plurality of atomizers (also not shown). The atomizers introduce a treatment fluid into IPC 498,

In an embodiment IPC 498 includes a demister 603 arranged in first flow path 532. Demister 603 may take on a variety of forms including a vane type (chevron) flow passage demister, a knitted wire mesh, metal strips welded in a chevron configuration, parallel corrugated surfaces arranged in a direction of flow or the like. Demister 503 may be wetted by central atomizer 596. Demister 603 increases a gas/liquid contact time resulting in enhanced mass transfer, kinetics and gas sweetening performance.

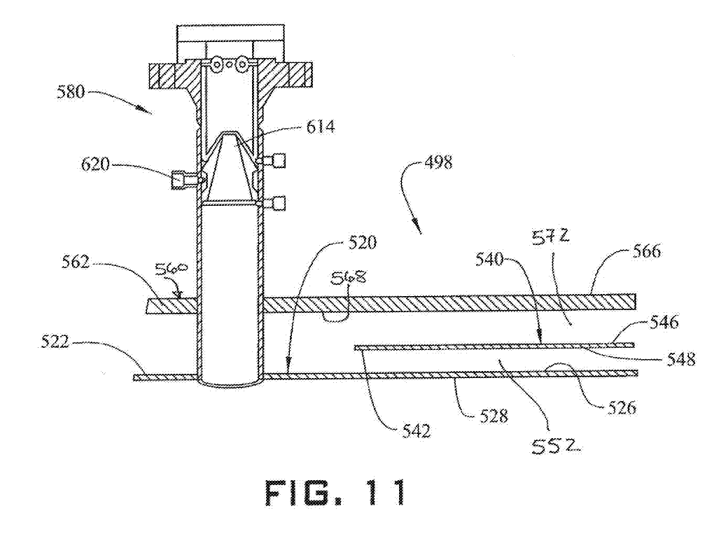

Further performance increases may be seen through the use of a demister pad 606 in outlet 582. Demister pad 606 may provide a final treatment step before the gas passes to, for example, gas/liquid separator 444. In an embodiment, additional sweetening performance may be achieved by passing the gas through a venturi, such as shown at 614 in FIG. 11 provided in inlet 580. Venturi 614 further enhances gas liquid mixing. Inlet 580 may also include a scavenging or recycle gas inlet 620 arranged at venturi 614. As an alternative, or in addition to venturi 614, a fogging nozzle (not shown) may be employed to pre-treat gas passing into IPC 498.

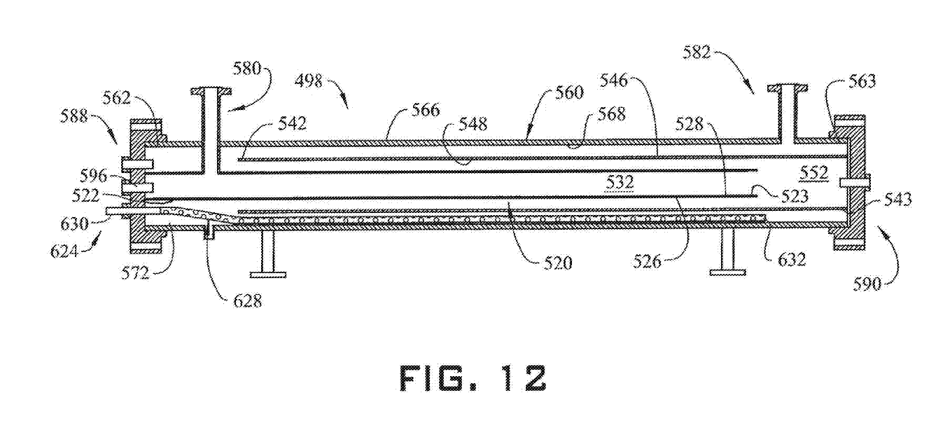

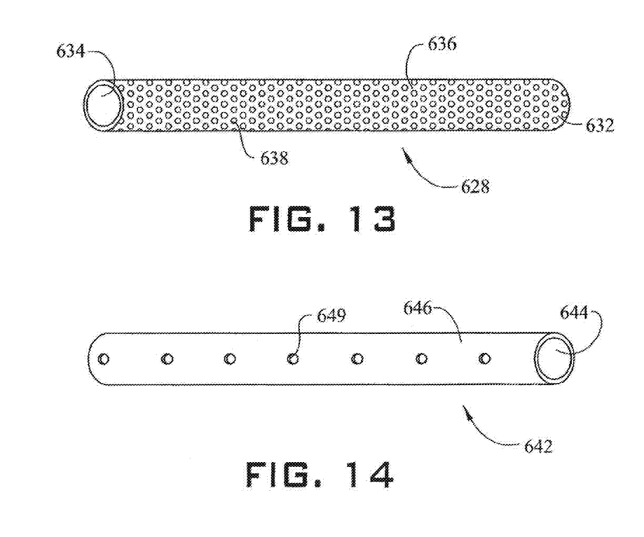

Reference will now follow to FIG. 12, wherein like reference numbers represent corresponding parts in the respective views, in describing a gas bubbler system 624 in accordance with an exemplary aspect. Gas bubbler system 624 includes a bubbler tube 628 having a first axial end 630 and an opposing second axial end 632. As shown in FIG. 13, bubbler tube 628 includes an inner surface 634, an outer surface 636, and a plurality of openings 638 that extend through inner and outer surfaces 634 and 636. Openings 638 extend between first end 630 and second end 632 annularly about bubbler tube 628. FIG. 14 depicts a bubble tube 642 in accordance with another exemplary aspect. Bubble tube 642 includes an inner surface 644, and an outer surface 646. A plurality of axially aligned openings 649 extend through inner and outer surfaces 644 and outer surface 646.

At this point, it should be understood that while only a single bubble tube 628 is shown, multiple bubble tubes may be employed. For example, bubble tubes may extend from first end cap 588 into third flow passage 572 at a 5 O'clock position and a 7 O'clock position. With this arrangement, a portion of untreated sour gas (natural gas containing significant amounts of acidic gases such as hydrogen sulfide and carbon dioxide) passing into IPC 498 may enter through gas bubbler tube 628 and be bubbled through liquid within IPC 498. In this manner, sweetening may be further enhanced by increasing a mass transfer between H2S from gas bubbles passing through scavenger liquids in IPC 498. As much as between about 30% and 70% of sour gas passing through IPC 498 may enter through gas bubbler system 624.

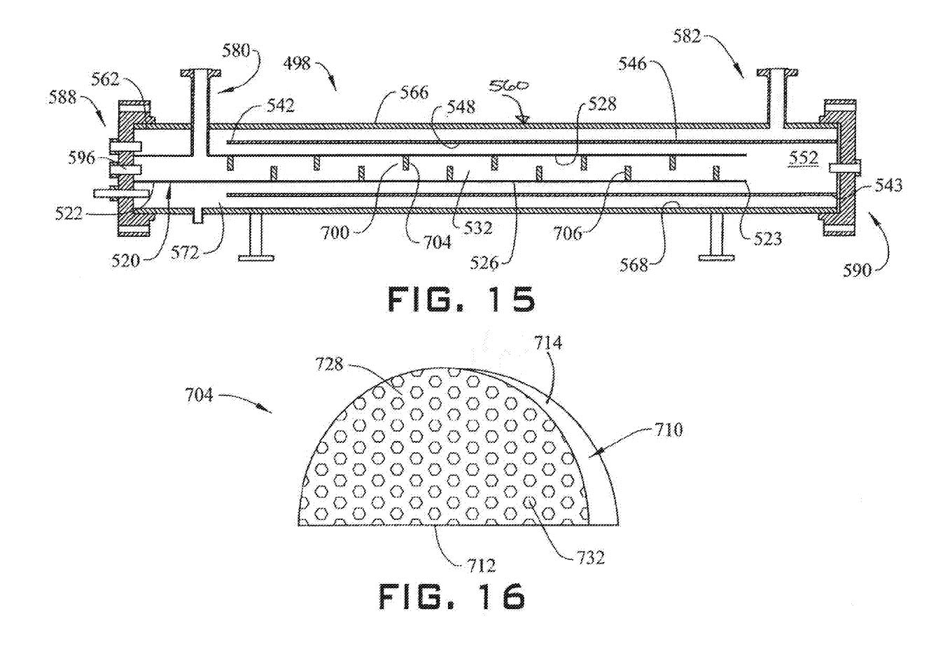

Reference will now follow to FIG. 15, wherein like reference numbers represent corresponding parts in the respective views, in describing a baffle system 698 in accordance with an aspect of an exemplary embodiment. In an embodiment, a plurality of baffles 700 may extend along first flow path 532. Plurality of baffles 700 may include a first plurality of baffles, one of which is indicated at 704, that project radially inwardly and downwardly into first flow path 532 and a second plurality of baffles 706, interposed with the first plurality of baffles 704, that project radially inwardly and upwardly into first flow path 532. The relative position may vary. That is baffles may project into first flow path 532 from opposing sides, such as left/right or at other annular positions.

Turning to FIG. 16, one of the first plurality of baffles 704 is shown to include a body 710 including a first edge 712 that is substantially linear and a second edge 714 that is curvilinear and shaped to match a profile of inner surface 528. Body 710 includes a first surface 728 and a second, opposing surface (not separately labeled). A plurality of holes or openings 732 extend through body 710 from first surface 728 through the second, opposing surface. Baffles force source gas to flow more centrally within first flow path 532. Interposing baffles such as shown in FIG. 15 increases an overall residence time of the sour gas/liquid mixture within IPC 498 to promote enhanced scavenging performance.

At this point, it should be understood that the IPC in accordance with exemplary embodiments may include any one or more of the above-described features, recycling, demisters, bubblers and baffles, in order to achieve desired formation fluid sweetening effects. Additionally, as discussed herein, it should be appreciated that the in-line pipe contactor may be employed in combination with other scavenger units for sweetening gas to meet various H2S specifications.

Set forth below are some embodiments of the foregoing disclosure:

### Embodiment 1

A method of removing impurities from formation fluids comprising: introducing a formation fluid into a first end of a first tubular; directing the formation fluid along a first flow path toward a second end of the first tubular; redirecting the formation fluid along a second flow path defined by a second tubular arranged radially outwardly of the first flow path toward the first end; spraying a treatment fluid along the first flow path into the formation fluid; and directing a treated formation fluid through an outlet fluidically connected to the second flow path.

### Embodiment 2

The method according to any previous embodiment, wherein spraying the treatment fluid includes introducing an atomized spray of triazine into the formation fluids.

### Embodiment 3

The method according to any previous embodiment, further comprising: introducing additional treatment fluid into the formation fluids flowing along the second flow path.

### Embodiment 4

The method according to any previous embodiment, wherein introducing the treatment fluid includes introducing a first portion of a selected amount of treatment fluid and introducing the additional treatment fluid includes introducing a second portion of the selected amount of treatment fluid.

### Embodiment 5

The method according to any previous embodiment, further comprising: redirecting the formation fluids into a third flow path radially outwardly of the second flow path toward the second end of the second tubular.

### Embodiment 6

The method according to any previous embodiment, further comprising: creating turbulence in the formation fluids flowing along one of the first flow path and the second flow path.

### Embodiment 7

The method according to any previous embodiment, wherein creating turbulence includes passing the formation fluid over and between a plurality of interposed baffles extending along the first flow path.

### Embodiment 8

The method according to any previous embodiment, wherein creating turbulence includes passing a portion of the formation fluid through openings in the plurality of baffles.

### Embodiment 9

The method according to any previous embodiment, wherein creating turbulence includes passing the formation fluid over a plurality of trip inducers extending along the first flow path.

### Embodiment 10

The method according to any previous embodiment, wherein creating turbulence includes passing the formation fluid over a plurality of trip inducers extending along each of the first flow path, the second flow path, and the third flow path.

### Embodiment 11

The method according to any previous embodiment, further comprising: sensing an amount of impurities in the formation fluid with one or more sensors.

### Embodiment 12

The method according to any previous embodiment, wherein introducing the formation fluids into the first end of a tubular includes passing the formation fluids through a venturi arranged in an inlet of the tubular.

### Embodiment 13

The method according to any previous embodiment, wherein introducing the formation fluids into the first end of a tubular includes passing the formation fluids over a demister arranged along the first flow path.

### Embodiment 14

The method according to any previous embodiment, wherein directing the treated formation fluid through the outlet includes passing the treated fluid over a demister pad arranged in the outlet.

### Embodiment 15

The method according to any previous embodiment, further comprising: passing an amount of the treated fluid through a recycling outlet arranged upstream of the outlet.

### Embodiment 16

The method according to any previous embodiment, wherein passing the amount of treated fluid through the recycling outlet includes recycling between 10% and 99.9% of the treated fluid through the recycling outlet.

### Embodiment 17

The method according to any previous embodiment, further comprising: selecting the amount of treatment fluid for recycling based on an amount of Hydrogen Sulfide in the treated fluid.

### Embodiment 18

The method according to any previous embodiment, wherein directing the treated formation fluid through the outlet includes passing the treated formation fluid into a separator.

### Embodiment 19

The method according to any previous embodiment, further comprising: introducing an amount of treatment liquid into the first flow path.

### Embodiment 20

The method according to any previous embodiment, further comprising: passing an amount of the formation fluid through a bubbler tube extending into the first flow path.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of removing impurities from formation fluids comprising:
introducing a formation fluid into a first end of a first tubular;
directing the formation fluid along a first flow path toward a second end of the first tubular;
redirecting the formation fluid along a second flow path defined by a second tubular arranged radially outwardly of the first flow path toward the first end;
spraying a treatment fluid along the first flow path into the formation fluid; and
directing a treated formation fluid through an outlet fluidically connected to the second flow path.

2. The method according to claim 1, wherein spraying the treatment fluid includes introducing an atomized spray of triazine into the formation fluids.

3. The method of claim 1, further comprising: introducing additional treatment fluid into the formation fluids flowing along the second flow path.

4. The method of claim 3, wherein introducing the treatment fluid includes introducing a first portion of a selected amount of treatment fluid and introducing the additional treatment fluid includes introducing a second portion of the selected amount of treatment fluid.

5. The method of claim 1, further comprising: redirecting the formation fluids into a third flow path radially outwardly of the second flow path toward the second end of the second tubular.

6. The method of claim 1, further comprising: creating turbulence in the formation fluids flowing along one of the first flow path and the second flow path.

7. The method of claim 6, wherein creating turbulence includes passing the formation fluid over and between a plurality of interposed baffles extending along the first flow path.

8. The method of claim 7, wherein creating turbulence includes passing a portion of the formation fluid through openings in the plurality of baffles.

9. The method of claim 6, wherein creating turbulence includes passing the formation fluid over a plurality of trip inducers extending along the first flow path.

10. The method of claim 6, wherein creating turbulence includes passing the formation fluid over a plurality of trip inducers extending along each of the first flow path, the second flow path, and the third flow path.

11. The method of claim 1, further comprising: sensing an amount of impurities in the formation fluid with one or more sensors.

12. The method of claim 1, wherein introducing the formation fluids into the first end of a tubular includes passing the formation fluids through a venturi arranged in an inlet of the tubular.

13. The method of claim 1, wherein introducing the formation fluids into the first end of a tubular includes passing the formation fluids over a demister arranged along the first flow path.

14. The method of claim 1, wherein directing the treated formation fluid through the outlet includes passing the treated fluid over a demister pad arranged in the outlet.

15. The method of claim 1, further comprising: passing an amount of the treated fluid through a recycling outlet arranged upstream of the outlet.

16. The method of claim 15, wherein passing the amount of treated fluid through the recycling outlet includes recycling between 10% and 99.9% of the treated fluid through the recycling outlet.

17. The method of claim 16, further comprising: selecting the amount of treatment fluid for recycling based on an amount of Hydrogen Sulfide in the treated fluid.

18. The method of claim 1, wherein directing the treated formation fluid through the outlet includes passing the treated formation fluid into a separator.

19. The method of claim 1, further comprising: introducing an amount of treatment liquid into the first flow path.

20. The method of claim 19, further comprising: passing an amount of the formation fluid through a bubbler tube extending into the first flow path.
